(19) United States
(12) Patent Application Publication
(10) Pub. No.: US 2007/0260547 A1
(43) Pub. Date: Nov. 8, 2007

(54) System and Method for Purchasing Digital Content

(75) Inventor: Julian Little, Cremorne (AU)

Correspondence Address: FISH & RICHARDSON P.C., P.O. BOX 1022, MINNEAPOLIS, MN, 55440-1022, US

(73) Assignee: ON Q TECHNOLOGIES PTY LTD., Eaglemont (AU)

(21) Appl. No.: 11/744,670

(22) Filed: May 4, 2007

(30) Foreign Application Priority Data
May 5, 2006 (AU) 2006902372

(51) Int. Cl. H04L 9/00

(52) U.S. Cl. 705/52

(57) ABSTRACT

A merchant can offer digital content online and receive payment from consumers thereof where the merchant has established at least one online account to receive payments and has associated same with a merchant user device. The merchant provides digital content for offer to consumers online, and an online micro-payment facility receives a consumer request to purchase digital content. Upon verifying receipt of valid payment, the facility transfers the payment, or portion thereof, to the merchant's online account. The merchant retrieves the payment, or portion thereof, upon presentation of the merchant user device to a facility operably connected to the online account.

### FIELD OF THE INVENTION

This invention relates generally to the field of purchasing and receiving payment for digital content and in particular, to purchasing and receiving payment for online digital content or online activities. More specifically, the invention relates to a method, system, computer instruction code, and/or apparatus to facilitate the purchasing of online digital content and providing payments to merchants and/or consumers for the supply of the online content and/or services or for activities performed online.

### BACKGROUND OF THE INVENTION

Digital Rights Management (DRM) schemes are becoming increasingly popular as creative content is made available online for consumers to download. Creators and distributors suffer financial loss due to fraudulent copying and various schemes have been developed to prevent or discourage fraudulent copying.

As part of this process, creators and distributors are increasingly offering creative content online for consumers to purchase and download for a relatively small purchase price. For example, in most instances a song may be purchased for approximately one dollar and photographs may be purchased for less than one dollar.

Presently, arrangements exist to receive payments from consumers and forward those payments to the relevant owner of the digital content. These arrangements are generally referred to as “micro-payment facilities” and they act to receive a purchase request from a consumer, issue the requested online digital content to the consumer upon receipt of a valid payment, and forward the payment, or a portion thereof, received from the consumer to the content owner.

Usually, payments forwarded to a content owner are transferred to either a bank or credit account that is owned/controlled by the content owner.

However, the administrative overhead associated with establishing and operating banking arrangements with each and every content owner's bank for the purpose of transferring funds is significant and relatively expensive. Whilst this administrative cost may be amortised over all payments that are processed, in the instance of a large number of relatively small payment amounts, the relative proportion of the total payment amount that must be attributed to cover the administrative overhead cost becomes significant and potentially causes the supply of low cost digital content to become commercially unfeasible with respect to current market expectations, or at least causes the overall cost of providing digital content to increase in view of the likely increase in the number of low cost transactions.

A further complicating factor is the inherently global nature of ecommerce and the sale/distribution of digital content across international borders. In order for a micro-payment facility to provide digital content across international borders, it would be necessary for the facility to provide direct transfers of credit from one bank in one country to another bank in another country. If international banking arrangements between the two respective countries do not exist it may not be possible to conduct a transfer and in any event, if transfers were possible, the micro-payment facility would need an account with every bank in every country where a digital content merchant resides. In order to reduce the number of banks with which the facility would need to establish arrangements, it is likely that a micro-payment facility would require merchants to establish accounts with a particular bank which may not be appreciated by merchants.

Further, in some countries, the banking system is less developed or non-existent and in those countries, content owners and consumers may not have any form of an established account such as a bank or credit account into which payments may be transferred.

Accordingly, it is an object of the present invention to facilitate the purchasing of online digital content and forwarding payment for same, and/or for online activities, without requiring the digital content owner or a consumer to require either a bank or credit account.

Any discussion of documents, devices, acts or knowledge in this specification is included to explain the context of the invention. It should not be taken as an admission that any of the material formed part of the prior art base or the common general knowledge in the relevant field of technology on or before the priority date of the claims herein.

### SUMMARY OF THE INVENTION

Method

According to one aspect, the present invention provides a method for a merchant to offer digital content online and receive payment from consumers thereof where the merchant has established at least one online account to receive payments and has associated same with a merchant user device, the method including the steps of:

the merchant providing digital content for offer to consumers online;

an online micro-payment facility receiving a consumer request to purchase digital content and upon verifying receipt of valid payment, the facility transferring the payment, or portion thereof, to the merchant's online account; and

the merchant retrieving said payment, or portion thereof, upon presentation of the merchant user device to a facility operably connected to the online account.

In one embodiment, the micro-payment facility is connected to a digital communications network and maintains a database of records pertaining to the online accounts belonging to merchants and/or consumers. In addition, the micro-payment facility may also maintain a database of online digital content offered by merchants for potential purchase by consumers. In other embodiments, the micro-payment facility may not directly manage digital rights belonging to merchants but may be interfaced to a digital rights management facility and enable the issuance of digital content from a digital rights management facility to a consumer upon verification of receipt of valid payment from the consumer.

In an embodiment, the micro-payment facility maintains a database of online accounts for both merchants and consumers and upon sale of digital content to a consumer, the micro-payment facility debits the online account of the consumer for the purchase of the digital content and transfers an amount for the purchase to the online account of the relevant merchant who is the owner of the digital content.

According to another aspect, the present invention provides a method of a consumer conducting transactions in relation to digital content where the consumer has established at least one online account to provide and/or receive payments and has associated same with a consumer user device, the method including the steps of:

the consumer crediting an online account with funds;

the consumer accessing digital content and providing payment for same from the online account upon supply of said online account details;

a micro-payment facility receiving authorisation for payment for digital content from the consumer and enabling the supply of said digital content to the consumer.

In an embodiment, the consumer may also receive payments to their online account in the event that they perform some activity online for which they are to receive payment and may retrieve payment upon presentation of their user device to a facility operably connected to their online account.

System

In another aspect, the present invention provides a system for an online merchant to offer digital content online and receive payment from consumers thereof, the system including:

merchant and consumer communication devices connected to a data communications network said devices operable to establish online accounts and to associate same with a merchant and consumer device respectively;

a micro-payment facility connected to the data communications network said facility being accessible by the merchant and/or consumer and operable to manage online digital content submitted by the merchant for offer to consumers and receive requests for purchase of online digital content from consumers;

a payment and transfer facility operable to validate a purchase from a consumer and transfer funds from the relevant consumer online account to the relevant merchant online account and upon completion of same, cause the transmission of purchased digital content to the consumer; and

a funds retrieval facility connected to the data communications network operable to allow access to funds in a merchant and/or consumer online account upon presentation of the merchant/consumer device to the retrieval facility.

In yet another aspect, the present invention provides a system for facilitating consumer transactions for digital content, the system including:

a consumer communications device connected to a data communications network and operable to establish an online account and associate same with a consumer device;

a crediting facility operable to enable the consumer to credit the consumer online account with funds;

a micro-payment facility connected to the data communications network and accessible by the consumer said micro-payment facility operable to manage online digital content and receive requests for purchase from consumers;

a payment and transfer facility operable to validate a purchase from a consumer and debit funds from the consumer online account for payment to the owner of the purchased digital content and upon completion of same causing the transmission of purchased digital content to the consumer.

In an embodiment, the consumer also receives payments to their online account for the performance of activities online and in this embodiment, the system preferably includes a funds retrieval facility connected to the data communications network and operable to allow access to funds in a consumer online account upon presentation of the consumer device to the retrieval facility.

A merchant and/or consumer communication device may include a personal computer, a personal digital assistant, a mobile (cell) phone or any other suitable device that is operable to connect online to a data communications network and from which a consumer may sample and elect to purchase online digital content.

A funds retrieval facility may include any device that is operably connected to a data communications network and through which the facility may obtain details regarding a users online accounts upon presentation of the merchant or consumer device to that facility. In a particularly preferred embodiment, the funds retrieval facility includes a retail merchant terminal connected to a Point of Sale (POS) communications network and in the instance of a merchant/consumer device in the form of a magnetic strip card, the merchant and/or consumer may present their magnetic strip card for swiping through the terminal and withdraw funds from their online account. In another embodiment, the funds retrieval facility includes an Automatic Teller Machine (ATM) that is connected to a data communications network and operable to access details of a merchant and/or consumer online account.

Computer Program Code

According to another aspect, the present invention provides a computer program embodied on a computer readable medium for enabling a merchant to offer digital content online and receive payment from consumers thereof where the merchant has established an online account to receive payments and has associated same with a merchant user device, the computer program including the following:

computer instruction code enabling a merchant to provide digital content for offer to consumers online;

computer instruction code enabling a consumer to access said digital online content and request purchase of the digital content;

computer instruction code to connect a consumer to a micro-payment facility such that the micro-payment facility receives said consumer request and upon verifying receipt of valid payment, the facility transfers the payment, or portion thereof, to the merchant's online account and causes transmission of the digital content to the consumer; and

computer instruction code to retrieve merchant payments upon presentation of the merchant user device to a facility operably connected to the merchants online account.

According to another aspect, the present invention provides a computer program embodied on a computer readable medium for assisting consumers to conduct transactions in relation to digital content where the consumer has established an online account to provide and/or receive payments and has associated same with a consumer user device, the computer program including the following:

computer instruction code for crediting the consumer online account with funds;

computer instruction code enabling access to digital content and for providing payment for same from the consumer online account upon supply of said online account details;

computer instruction code for connecting a consumer to a micro-payment facility to receive authorisation for payment for digital content and transmitting said digital content to the consumer.

In an embodiment, the computer program also includes computer instruction code for the consumer to receive payments to their online account in the event that they perform some activity online for which they are to receive payment. In a further embodiment, computer instruction code is also included to enable a consumer to retrieve payment upon presentation of their user device to a facility linked to their online account.

The computer instruction code may result in computer instructions that are implemented integrally to a computer or over a network using separate software components. The code may also include components of existing software that effect functions in cooperation with dedicated code developed specifically for the present invention.

The merchant and/or consumer user device may include a range of devices for the purpose of identifying the online account belonging to a merchant and/or consumer. For example, the device may be in the form of a card comprising a barcode to identify the online account. Alternatively, the user device may be in the form of any other suitable storage device such as an RFID device, smart card, a biometric chip card or a suitably configured mobile phone or personal digital assistant. In an embodiment of the invention, the merchant and consumer user devices are in the form of a magnetic strip card wherein the magnetic strip is programmed to identify the online account of the merchant and consumer respectively.

In this respect, although it may be possible for merchants and/or consumers to retrieve payments in various forms including the use of funds in the online account for the payment of invoices or for the supply of goods and/or services from an allied supplier who will accept payment by the transfer of funds from the online account, it is preferred that the merchant and/or consumer use their respective user devices to withdraw payments from their online accounts in the form of cash. In this instance, the merchant and consumer magnetic strip cards are preferably accepted in ATMs that allow the owner of the online account to withdraw funds from the account in the form of cash or use an available amount of funds in an online account for payments at POS terminals or on the internet at general Card Network accepting payment pages (for example, use the card as a Visa card on the internet).

In one embodiment, the micro-payment facility is a computing system with a website interface that enables merchants/consumers to register their details for the purpose of establishing an online account. Further, the website interface of the micro-payment facility may also enable consumers to sample and purchase digital content that is maintained by a digital rights management facility. In an embodiment, the digital rights management facility is integral to the micro-payment facility.

In an embodiment, the website interface of the micro-payment facility also enables merchants to submit digital content to a digital rights management facility for potential purchase by consumers. In addition to merchants receiving payment for the purchase of digital content, it is also possible for consumers to receive payments to their online account as a result of performing activities online. For example, in one embodiment the consumer communications device is a gaming console and the consumer participates in an online game with many other players. In this instance, a prize in the form of a sum of money may be offered to the winner of the game and upon winning a game, the consumer may have funds transferred into their online account, said funds representing the winnings for the game. In this particular instance, the ability for consumers to access funds from their online account may be limited and require consumers to only use those funds in their online account for the purpose of purchasing online digital content.

In an embodiment, funds retrieval facilities are only made available to customers by a predefined set of operators of POS terminal equipment, effectively forming a “closed” environment within which funds may be retrieved. In this embodiment, only the predefined set of operators would be capable of effecting the required actions for consumers and online merchants to access the funds in their online accounts.

By only allowing certain predefined operators to effect a funds retrieval action, it would be possible to provide the owners of those devices a competitive advantage with respect to offering the service of funds retrieval for consumers and merchants with online accounts. Further, by adopting this approach, it is also possible to ensure that all participating operators able to effect funds retrieval have entered into appropriate contractual arrangements detailing various liability issues and the agreed process that would be implemented in the event that a dispute arose between a merchant and/or the operator of a funds retrieval device or the operator's bank. Any dispute regarding the settlement of amounts caused by issuing a request for funds retrieval will at least be able to be resolved in accordance with prior agreements.

When effecting funds retrieval within a closed environment, only those participating operators would be relevant to consumers and/or merchants with online accounts seeking to retrieve funds from their accounts. In one embodiment of the invention, it is expected that a closed environment would not include an automated cash dispensing apparatus and as such, once the value of a consumer and/or merchant's online account is increased by the supply of cash to a participating operator, it would no longer be possible for the card holder to withdraw a cash equivalent value from their online account. In this particular embodiment, a consumer is restricted to redeeming the value of their online account by purchasing online content although a consumer and/or merchant may redeem the value of any payments to their online accounts by purchasing goods and/or services from one or more operators within the closed environment. In this particular example, an operator may include a supermarket or chain of convenience stores and the value of payments to a consumer and/or merchants online account would only be available for purchasing goods from the supermarket or convenience store.

In a further embodiment, the predefined operators display a private label logo identifying those devices that may be used for the purpose of funds retrieval. In this embodiment, consumers and/or merchants holding a consumer and/or merchant device bearing the private label logo applicable to the closed environment would only approach operators displaying the private label logo thus indicating the ability for the consumer and/or merchant to retrieve payments from the operator of the device. This embodiment of the invention is particularly advantageous as it allows for the formation of a subset of operators within an existing POS network of operators. Further, any predefined subset of operators within a POS network of operators may be the only operators able to provide funds retrieval to consumers and/or merchants.

In an alternative embodiment, funds retrieval facilities are made available to customers by any operator of a POS terminal device, effectively forming an “open” environment in which funds retrieval may be effected. In this embodiment, any operator would be capable of effecting funds retrieval for a consumer and/or merchant.

Various embodiments may implement a range of rules and/or limitations with respect to the accessibility of funds in online accounts. For example, in one embodiment, whilst it is possible to access and withdraw funds from a merchant online account, it is not possible to retrieve funds from a consumer online account. This may be a preferred arrangement in the event that a facility is provided for people other than the consumer to credit funds into a consumer's online account. It may be possible for a parent to gift an amount into a child's consumer online account to enable the child to purchase online digital content. In this particular instance, the parent would most likely prefer their child to not be able to withdraw any funds gifted to the account in the form of cash. Alternatively, an arrangement may be established wherein only certain types of credits into a consumer's online account are restricted from withdrawal in the form of cash. Similarly, limitations may also be placed upon the operation of a merchant's online account and the retrieval of funds therefrom.

Of course, it is expected that there will be variations to the actual supply of user devices to consumers and merchants in each country in order to comply with local “Know Your Customer” Legislation and Regulations. In this respect, countries have differing requirements in an attempt to ensure that entities providing services that supply money identify their customer to reduce the incidence of money laundering from illegal activities.

Whilst the precise details may vary for individual countries, in one embodiment, consumer devices are unidentified and merchant devices are identified. It is expected that not identifying consumer devices as belonging to a particular consumer should not present difficulties in many countries as the consumer device will not have any value until the device is received, activated and funds credited to the consumer's online account. However, in the same embodiment, merchant user devices are identified as a merchant may commence receiving payments to their online account (and hence the account may have value) prior to the merchant receiving the user device. In any event, not identifying consumer devices enables a rapid deployment of cards to consumers globally.

### BRIEF DESCRIPTION OF THE DRAWINGS

One or more embodiments of the present invention will now be described with reference to the accompanying drawings, in which:

FIG. 1 is a process flow diagram detailing the steps associated with establishing a merchant/consumer online account in one embodiment; and

FIG. 2 is a diagrammatic representation of a an embodiment of a system according to the present invention.

### DETAILED DESCRIPTION OF AN EMBODIMENT

As previously indicated, there is a significant administrative overhead cost incurred by the operators of micro-payment facilities to manage and administer the transfer of payments to bank or credit accounts. In this respect, there is a significant administration burden associated with maintaining address changes associated with customer accounts, closing and opening of new accounts, reversing incorrect payments to accounts and maintaining details of payments to different banks residing in different countries. Clearly, as the number of banks and accounts requiring maintenance increases, the administrative cost associated with maintaining details and managing transfers between accounts significantly increases. In the instance of a typical micro-payment facility, it is not uncommon for the facility to maintain and manage payments to thousands of different bank accounts operated by many different banks across potentially many different countries with quite different banking systems and regulations regarding the support for direct crediting of bank accounts.

Of course, where the amounts transferred are effectively “micro” amounts (ie amounts ranging from a few dollars down to a few cents), any overhead administrative cost must be minimised as the amortisation of these costs over all micro-payment transactions can amount to a significant proportion of the amount of funds transferred. Clearly, any administrative cost incurred by a micro-payment facility will eventually be transferred to a consumer in order for the micro-payment facility to remain profitable. Accordingly, it is desirable to keep overhead administrative costs to a minimum whilst processing micro-payment transactions.

The present invention does not require any particular hardware or software implementation. It is to be understood that various other embodiments and variations of the invention may be produced without departing from the spirit or scope of the invention. The following description is provided to assist in understanding the practical implementation of one embodiment of the invention.

An online account is any account where the details of the account are accessible by connection to a data communications network. Preferably, the details include a record of the value in the account, the individual that owns the account and the identification of a user device associated with the account thus enabling the individual to present the user device to a connection point of the data communications network and for same to act as the authority to access funds in the account. In a one particular embodiment, another form of identification such as a Personal Identification Number (PIN) is also required before funds in an online account may be accessed.

Although the ability to retrieve funds from an online account is preferably effected by any type of network payment device (including any POS terminal equipment connected to a data communications network and operable to access online account details), for the purposes of the description of the instant embodiment, only one particular type of network payment device, namely an ATM, will be described. In any event, irrespective of the network payment device that is used for the purpose of retrieving funds, it is preferred that any funds accessed by a consumer or merchant is made available to them in the local currency where the network payment device resides. In this respect, the system preferably conducts the foreign exchange conversion of funds from the currency in which the online account is established to the local currency where the network payment device resides. Accordingly, as the consumer and/or merchant travels from country to country, it is possible for them to access funds in the local currency at each network payment device that they use.

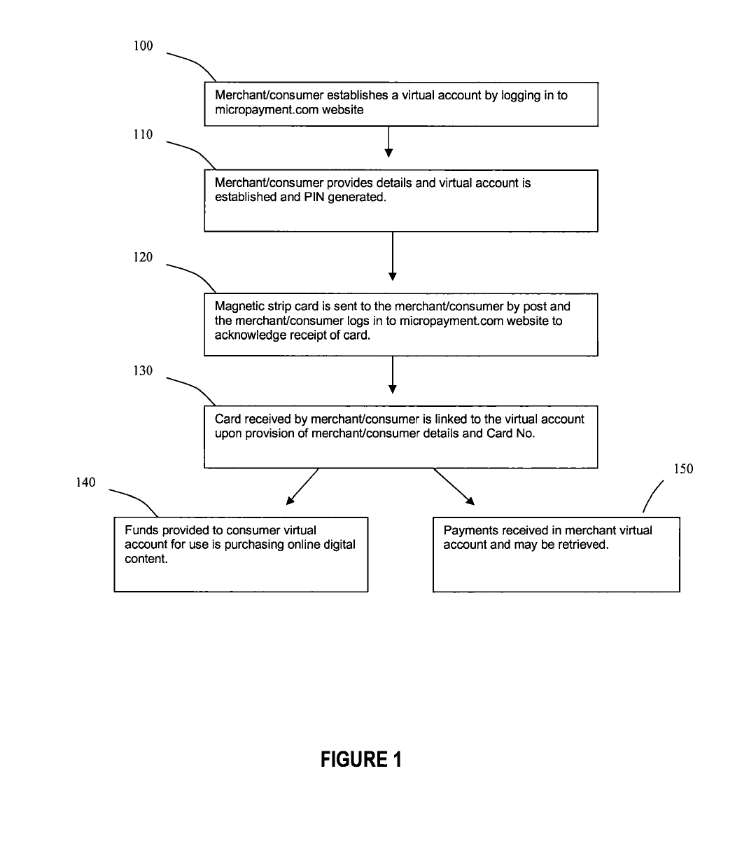

With reference to FIG. 1, a process flow diagram detailing the steps associated with establishing a merchant/consumer online account is detailed. In one embodiment, the micro-payment facility is a computing system connected to the internet with a website interface and the process commences at step 100 with merchants or consumers establishing an online account by logging into the micro-payment facility website. At step 110, the merchant or consumer provides their details and an online account is established.

In this embodiment, the user device for either the merchant or consumer is a magnetic strip card that may be used for either crediting or withdrawing funds to/from the online account. An initial PIN of 0000 is generated by the micropayment.com website at the time an online account is established. At step 120, a magnetic strip card is posted to the merchant or consumer and upon receipt, the merchant or consumer may activate their online account by logging in to the micropayment.com website. Preferably, the consumer/merchant has received a non-zero PIN independently (by email, SMS or similar communication) at around the same time that they receive their magnetic strip card. To activate the online account, the consumer/merchant logs into a secure area of the micropayment.com website and provides the separately received PIN.

In any event, at step 130, the magnetic strip card received by the merchant or consumer is linked to the online account upon provision of the merchant or consumer details and the card number.

Once a consumer has received their magnetic strip card and linked same to their online account, they may credit the online account by presentation of the magnetic strip card to a facility operable to receive the funds and credit same to the online account. For example, in one embodiment of the invention, the consumer may provide funds “over the counter” at a retail outlet that is equipped with a Point Of Sale (POS) transaction terminal and the consumer may provide funds to an operator at the retail outlet who then swipes the magnetic strip card and credits the online account by the amount of funds provided by the consumer. Of course, in this embodiment, the online account must be accessible to the POS transaction network.

At step 150, payments are received into a merchant's online account as a result of consumers purchasing digital content posted on the micropayment.com website and funds being transferred to the merchant's online account for same. In one embodiment, the merchant may then proceed to a Network Payment Device such as an ATM and insert their magnetic strip card and withdraw payments from their online account from the payment device in the form of cash. Of course, in this embodiment, the ATM must be able to access the online account associated with the micropayment.com website.

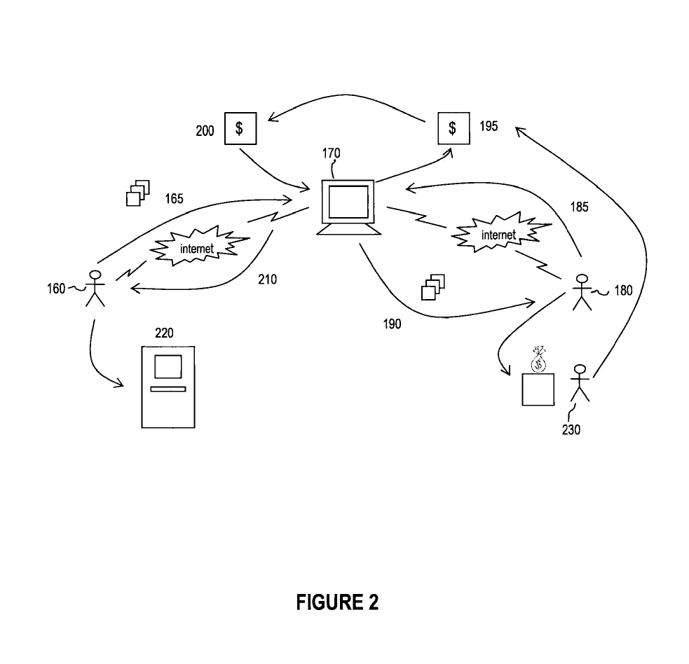

With reference to FIG. 2, a diagrammatic representation of a system according to an embodiment of the invention is detailed. In FIG. 2, a merchant 160, forwards digital content (165) to a combined micro-payment and digital rights management facility 170. The micro-payment/digital rights management facility 170 is hosted by a computing system connected to the internet and includes a website interface. Upon receipt of the digital content owned by the merchant 160, the micro-payment/digital rights management facility 170 hosts the digital content for subsequent sampling and potential purchase by consumers.

Subsequent to hosting merchant digital content, a consumer 180 accesses the website 170 and samples the available digital content. Upon deciding to purchase digital content, the consumer 180 provides details (185) of their online account details (195) and indicates their request to purchase online digital content. The website 170 accesses the consumer's online account 195 to ensure that there are sufficient funds to cover the purchase of the digital content requested by the consumer 180. On the basis that sufficient funds reside in the consumer's online account 195, the micro-payment/digital rights management facility transmits the requested digital content 190 to the consumer 180 and arranges a transfer of funds from the consumer online account 195 to the merchant online account 200 to cover the purchase of the merchant digital content 165.

The account balance of the merchant's online account is recorded and maintained by the micro-payment facility 170 and is accessible to the merchant 160 by connection to the micro-payment facility website 170 through a data communications network such as the internet. Alternatively, in another embodiment, the details of consumer and merchant online accounts (including balances) are maintained by a separate facility that manages the accounts and access to card information and users may access the information by logging in to an online account hosted by a web-site connected to the card management facility. The merchant 160 may access their online account details and receive communication of same 210. The merchant 160 may then elect to retrieve funds from their online account 200 and in a particularly preferred embodiment, the merchant 160 may proceed to an ATM 220 and insert their magnetic strip card in order to access the funds available in their online account 200. As usual, before receiving funds in the form of cash from the ATM 220, the merchant 160 will usually be required to enter a PIN and in this instance, the merchant would enter their selected PIN in order to retrieve funds from the online account 200 in the form of cash. Of course, the authorisation for the ATM to provide cash may emanate from an intermediate host that connects the POS network to the host of the online accounts and in this instance, the usual process for making a request for funds from an online account and receiving authorisation to provide same would be followed.

Of course, as the consumer 180 continues to make purchases of online digital content, the balance of their online account 195 will decrease over time. In order to continue to purchase online digital content, the consumer 180 will need to credit their online account 195. Crediting of the consumers online account may occur by a transfer of value from a credit card to the online account.

In one embodiment, the consumer 180 may proceed to a retail outlet and provide funds to an operator 230 who then credits the consumer online account 195 with an amount equivalent to the funds provided, or a portion thereof to take into account a handling fee. In one embodiment of the invention, the retail outlet operator 230 credits the consumer online account 195 by using the consumer's magnetic strip card and swiping same through a POS transaction terminal that is able to access the consumer's online account 195 that is associated with the micro-payment/digital rights management facility 170 or an intermediate account. Upon crediting the consumer's account 195, the consumer 180 may continue to make further purchases of online digital content.

Of course, limitations or specific operational arrangements with respect to the online accounts of merchants and/or consumers may be implemented in a manner that suits the specific requirements of the operator of a micro-payment/digital rights management facility. For example, in one embodiment of the invention, a single online account may be established for an individual irrespective of whether the individual is acting as a consumer or a merchant. In this instance, a single user device such as a magnetic strip card would be provided to the individual and any funds received into the individual online account may be used for the purpose of purchasing online digital content or alternatively may be retrieved from an ATM in the form of cash. Alternatively, in the embodiment operating a single user device linked to a single online account, any amounts credited to the account may not be converted to cash whereas any payments transferred into the account from another online account may be accessible for retrieval in the form of cash.

In another embodiment, a single user device may be issued to an individual and linked to two separate online accounts, namely, a consumer online account and a merchant online account respectively. Of course, the online account that is used in any particular instance is dependent upon whether the individual is acting in the mode of a consumer or a merchant. In this instance, any funds allocated to the consumer online account may be restricted from retrieval (ie limited for use only for providing payments for digital content) and any payments to the merchant online account may be retrieved from that account in the form of cash from an ATM.

In a further embodiment, two different types of magnetic strip cards are issued, one for consumers and one for merchants. In the instance of an individual wishing to act in the mode of a consumer and a merchant, they would be issued with two separate cards and whilst they would have unlimited access to any funds residing in their merchant online account, any funds residing in their consumer online account would be limited to use only for the purpose of purchasing online digital content.

In yet a further embodiment, an online account is operated by two different types of user device, namely a load card and a spend card. In this example, the load card is used to credit funds to an online account for subsequent use to purchase online digital content. The spend card in this instance is used to access payments to the online account and to use those funds to purchase other items or to convert those funds to cash.

In any of the instances described above where a consumer performs activities online, and hence receives payment for those activities, the payment may be treated in the same manner as a merchant payment and hence may be accessed by the consumer and used for purposes other than purchasing online digital content. Whilst many individuals may prefer to only operate in the mode of a consumer, in certain instances they may partake in online activities such as games or competitions and may receive winnings as a result of their participation in those activities. In this instance, any funds received as a result of participating in online activities may be treated in the same manner as payments to a merchant. Depending upon the particular scheme implemented by the micro-payment/digital rights management facility, it may be possible for consumers to have limited or unlimited access to any funds received as a result of participation in online activities.

A system according to the present invention overcomes or at least alleviates a significant administrative cost associated with purchases of online content and the forwarding of payments to the owners of purchased digital content.

In this respect, an embodiment of the invention provides consumers and/or merchants with the ability to present a user device to a network payment device and immediately access funds in their online account in the local currency where the network payment device resides. This may be effected relatively inexpensively and avoids the requirement to conduct a bank to bank transfer of funds that usually incurs a service charge of twenty dollars or more.

Further, an embodiment of the invention provides the ability to generate user devices such as magnetic strip cards for accessing funds in online accounts and forwarding same to consumers and/or merchants in any country in the world. This embodiment also provides accessibility to funds accumulated in an online account through any network payment device. Prior to the accumulation of funds in an online account, the user device has no value and can be sent to anyone by use of a local postal service without any concern regarding safe receipt.

With the inherently international nature of internet commerce, content owners may reside in many different countries. An ability to forward payments to content owners across borders such that the content owner can use a user device without the micro payment operator having to deal with multiple domestic banking arrangements across multiple countries significantly improves the scalability of micro-payment arrangements globally by avoiding otherwise constraining administrative costs.

It should be understood that many different schemes and arrangements pertaining to the operation of consumer and merchant online accounts and any limitations thereof may be implemented depending upon the particular circumstances of the micro-payment/digital rights management facility and all variations to such schemes should be considered within the scope of the present invention.

We claim:

1. A method for a merchant to offer digital content online and receive payment from consumers thereof where the merchant has established at least one online account to receive payments and has associated same with a merchant user device, the method including the steps of:
the merchant providing digital content for offer to consumers online;
an online micro-payment facility receiving a consumer request to purchase digital content and upon verifying receipt of valid payment, the facility transferring the payment, or portion thereof, to the merchant's online account; and
the merchant retrieving said payment upon presentation of the merchant user device to a facility operably connected to the online account.

2. A method as claimed in claim 1 wherein the micro-payment facility is connected to a data communications network and maintains a database of records pertaining to the online accounts belonging to merchants and/or consumers.

3. A method as claimed in claim 1 wherein the micro-payment facility maintains a database of online digital content offered by merchants for purchase by consumers.

4. A method as claimed in claim 1 wherein the micro-payment facility is operably connected to a digital rights management facility that issues digital content to a consumer upon verification of receipt of valid payment from the consumer.

5. A method as claimed in claim 1 wherein the micro-payment facility maintains a database of online accounts for both merchants and consumers and upon sale of digital content to a consumer the method includes the step of transferring value from the consumer's online account to the online account of the merchant who owns the rights to the online digital content.

6. A method of a consumer conducting transactions in relation to digital content where the consumer has established at least one online account to provide and/or receive payments and has associated same with a consumer user device, the method including the steps of:
the consumer crediting an online account with finds;
the consumer accessing digital content and providing payment for same from the online account upon supply of said online account details; and
a micro-payment facility receiving authorisation for payment for digital content from the consumer and enabling the supply of said digital content to the consumer.

7. A method according to claim 6 wherein the consumer receives payments to their online account for the performance of an online activity for which they receive payment.

8. A method according to claim 6 including the step of the consumer retrieving payment upon presentation of their user device to a facility operably connected to their online account.

9. A system for an online merchant to offer digital content online and receive payment from consumers thereof, the system including:
merchant and consumer communication devices connected to a data communications network said devices operable to establish online accounts and to associate same with a merchant and consumer device respectively;
a micro-payment facility connected to the data communications network said facility accessible by the merchant and/or consumer and operable to manage online digital content submitted by the merchant for offer to consumers and receive requests for purchase of online digital content from consumers;
a payment and transfer facility operable to validate a purchase from a consumer and transfer funds from the relevant consumer online account to the relevant merchant online account and upon completion of same cause the transmission of purchased digital content to the consumer; and
a funds retrieval facility connected to the data communications network operable to allow access to funds in a merchant and/or consumer online account upon presentation of the merchant/consumer device to the retrieval facility.

10. A system for facilitating consumer transactions for digital content, the system including:
a consumer communications device connected to a data communications network and operable to establish an online account and associate same with a consumer device;
a crediting facility operable to enable the consumer to credit the consumer online account with funds;
a micro-payment facility connected to the data communications network and accessible by the consumer said micro-payment facility operable to manage online digital content and receive requests for purchase from consumers;
a payment and transfer facility operable to validate a purchase from a consumer and debit funds from the consumer online account for payment to the owner of the purchased digital content and upon completion of same causing the transmission of purchased digital content to the consumer.

11. A system according to claim 10 wherein the consumer receives payments to their online account for the performance of activities online.

12. A system according to claim 11 including a funds retrieval facility connected to the data communications network and operable to allow access to funds in a consumer online account upon presentation of the consumer device to the retrieval facility.

13. A system according to either claim 9 or claim 10 wherein the merchant and/or consumer communication device includes one or more of the following:
a personal computer;
a personal digital assistant;
a mobile (cell) phone; or
any other suitable device that is operable to connect online to a data communications network and from which a consumer may sample and elect to purchase online digital content.

14. A system as claimed in either claim 9 or claim 12 wherein the funds retrieval facility includes a device that is operably connected to a data communications network and through which the facility may obtain details regarding a users online account upon presentation of the merchant or consumer device to that facility.

15. A system as claimed in either claim 9 or claim 12 wherein the funds retrieval facility includes a retail merchant terminal connected to a Point of Sale (POS) communications network and the merchant/consumer device is a magnetic strip card, the merchant and/or consumer presenting their magnetic strip card for swiping through the terminal to withdraw funds from their online account.

16. A system as claimed in either claim 9 or claim 12 wherein the funds retrieval facility includes an Automatic Teller Machine (ATM) that is connected to a data communications network and operable to access details of a merchant and/or consumer online account.

17. A computer program embodied on a computer readable medium for enabling a merchant to offer digital content online and receive payment from consumers thereof where the merchant has established an online account to receive payments and has associated same with a merchant user device, the computer program including the following:
computer instruction code enabling a merchant to provide digital content for offer to consumers online;
computer instruction code enabling a consumer to access said digital online content and request purchase of the digital content;
computer instruction code to connect a consumer to a micro-payment facility such that the micro-payment facility receives said consumer request and upon verifying receipt of valid payment, the facility transfers the payment, or portion thereof, to the merchant's online account and causes transmission of the digital content to the consumer; and
computer instruction code to retrieve merchant payments upon presentation of the merchant user device to a facility operably connected to the online account.

18. A computer program embodied on a computer readable medium for assisting consumers to conduct transactions in relation to digital content where the consumer has established an online account to provide and/or receive payments and associated same with a consumer user device, the computer program including the following:
computer instruction code for crediting the consumer online account with funds;
computer instruction code enabling access to digital content and for providing payment for same from the consumer online account upon supply of said online account details;
computer instruction code for connecting a consumer to a micro-payment facility to receive authorisation for payment for digital content and transmitting said digital content to the consumer.

19. The computer program as claimed in claim 18 wherein the computer program also includes computer instruction code for the consumer to receive payments to their online account in the event that they perform some activity online for which they are to receive payment.

20. The computer program as claimed in claim 18 wherein computer instruction code is included to enable a consumer to retrieve payment upon presentation of their user device to a facility operably connected to their online account.

21. The system as claimed in either claim 9 or claim 10 wherein the merchant and/or consumer device is any one or more of the following:
an RFID device;
a smart card;
a biometric chip card;
a magnetic strip card;
a suitably configured mobile phone; or
a suitably configured personal digital assistant.

22. The system as claimed in claim 21 wherein the merchant and consumer devices are programmed to identify the online account of the merchant and consumer respectively.

23. The system as claimed in either claim 9 or claim 10 wherein merchants and/or consumers use payments in their online account for the payment of invoices or the supply of goods and/or services from a supplier who accepts payment by the transfer of funds from the respective online account.

24. The system as claimed in either claim 9 or claim 10 wherein the merchant and/or consumer devices are accepted at ATMs thus enabling the owner of the online account to withdraw funds from the online account in the form of cash.

25. The system according to either claim 9 or claim 10 wherein the merchant and/or consumer devices are accepted by POS terminals operably connected to the merchant and/or consumers online account.

26. The system as claimed in either claim 9 or claim 10 wherein the micro-payment facility is a computing system with a website interface enabling merchants/consumers to register their details to establish an online account.

27. The system as claimed in claim 26 wherein the website interface of the micro-payment facility also enables consumers to sample and purchase digital content that is maintained by a digital rights management facility.

28. The system as claimed in claim 27 wherein the digital rights management facility is integral to the micro-payment facility.

29. The system as claimed in claim 26 wherein the website interface of the micro-payment facility also enables merchants to submit digital content to a digital rights management facility for potential purchase by consumers.

30. The system as claimed in claim 11 wherein the consumer communications device is a gaming console and the consumer participates in an online game with other online players.

31. The system as claimed in claim 11 wherein the activity results in a prize in the form of a sum of money and upon winning the prize, funds are transferred into the consumer's online account, said funds representing the prize.

32. The system as claimed in either claim 9 or claim 10 wherein consumers are limited to use of funds in their online account for purchasing online digital content.

33. The system as claimed in either claim 9 or claim 10 wherein consumers are restricted from withdrawing funds in their online account in the form of cash.

34. The system as claimed in either claim 9 or claim 10 wherein individuals other than the consumer can credit funds into a consumer's online account.
